(19) United States
(12) Patent Application Publication
(10) Pub. No.: US 2022/0345191 A1
(43) Pub. Date: Oct. 27, 2022

(54) METHOD AND APPARATUS FOR RECEIVING UNIT SPECIFIC BEAM MEASUREMENT AND REPORTING

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 17/861,099

(22) Filed: Jul. 8, 2022

Related U.S. Application Data
(63) Continuation of application No. PCT/CN2021/070944, filed on Jan. 8, 2021.
(60) Provisional application No. 62/961,083, filed on Jan. 14, 2020.

(51) Int. Cl. H04B 7/06; H04W 24/10; H04L 5/00; H04W 56/00

(52) U.S. Cl. CPC H04B 7/0686; H04W 24/10; H04L 5/0051; H04W 56/001

(57) ABSTRACT

A method for performing beam measurement, the method comprising: measuring at least one beam transmitted by at least one of a first network device and a second network device, and received by a first receiving unit of a terminal device, measuring at least one beam transmitted by at least one of the first network device and the second network device, and received by a second receiving unit of the terminal device, and determining, for the first and second receiving units (111, 112), the at least one best beam received by each receiving unit (111, 112).

### CROSS-REFERENCE TO RELATED APPLICATIONS

This application is a continuation application of PCT Patent Application No. PCT/CN2021/070944, entitled “METHOD AND APPARATUS FOR RECEIVING UNIT SPECIFIC BEAM MEASUREMENT AND REPORTING” filed on Jan. 8, 2021, which claims priority to and the benefit of U.S. Provisional Patent Application No. 62/961,083, filed on Jan. 14, 2020, all of which are incorporated herein by reference in their entirety.

### TECHNICAL FIELD

The present application relates to the field of communications, and more particularly to a method, terminal device, and network device for measuring and reporting beams using specific receiving units.

### BACKGROUND

An example communications system is the fifth generation (5G) New Radio (NR) system (5G/NR). In this system, power and interference based beam measurement are supported.

A terminal device (e.g. a user equipment (UE)) can be configured with up to 64 Channel State Information Reference Signal (CSI-RS) resources or Synchronization Signal/Physical Broadcast Channel (SS/PBCH) blocks for Layer 1 Reference Signal Received Power (L1-RSRP) measurement. The UE can select up to 4 CSI-RS resources or SS/PBCH blocks from those configured resources and then report the indicators of those selected CSI-RS resources or SS/PBCH blocks and corresponding L1-RSRP measurement results to a network device (e.g. a next generation Node Base (gNB) station).

However, the current beam measurement and reporting does not support multiple transmission-reception points (multi-TRP) transmission to a UE with multiple antenna panels or modules, due to the following reasons:

1) The gNB is not able to select two transmit beams from two different TRPs that can be used to transmit Physical Downlink Control Channel (PDCCH) or Physical Downlink Shared Channel (PDSCH) on overlapped symbols (simultaneously) based on the beam reporting.

2) In group-based beam reporting, the UE might report two CSI-RS Resource Indicators (CRIs) or SS/PBCH Resource Block Indicators (SSBRIs) that represent two transmit beams from the same single TRP and thus the report has no value for multi-TRP transmission.

3) Frequency Range 2 (FR2) includes frequency bands from 24.25 GHz to 52.6 GHz. Generally, in Frequency Range 2 (FR2), to receive multi-TRP transmission, the UE would use multiple Receive (Rx) antenna panels and use a different panel to receive PDCCH/PDSCH from different TRPs. The current beam reporting methods cannot support UE Rx panel-specific beam measurement reports.

4) Multi-TRP transmission has two deployment cases: the first case is the network devices have ideal backhaul so that they can coordinate on each PDSCH transmission. In this case, the network devices know whether the transmission overlaps or not for each PDSCH transmission and thus the network devices can choose Tx beam accordingly. The second case is the network devices do not have ideal backhaul and thus they cannot coordinate on each individual PDSCH transmission. In this case, one network device does not know whether one PDSCH transmission overlaps with PDSCH transmission from another network device. Therefore, the network devices may prepare for the worst case and choose Tx beams for PDSCH that can be received by the UE simultaneously.

### SUMMARY

Embodiments of the present application provide a method, terminal device, and a network device for measuring and reporting on multiple beams that aim to overcome problems associated with conventional methods and apparatuses.

According to embodiments, there is provided a method for performing beam measurement, the method comprising: measuring at least one beam transmitted by at least one of a first network device and a second network device, and received by a first receiving unit of a terminal device, measuring at least one beam transmitted by at least one of the first network device and the second network device, and received by a second receiving unit of the terminal device, and determining, for the first and second receiving units, the at least one best beam received by each receiving unit.

The terminal device may be configured with a reporting setting configuration to control the terminal device to obtain receiving unit specific measurement results for reference signal resources of each beam.

The reporting setting configuration may be provided by an information element with a first higher layer parameter set to a first value to control the terminal device to obtain receiving unit specific measurement results for reference signal resources of each beam.

The reporting setting configuration may provide a second higher layer parameter that provides an index for one of at least one receiving unit of the terminal device.

The reference signal resources may comprise at least one of the following: channel state information reference signal (CSI-RS) resources or synchronization signal block (SSB) resources or synchronization signal/physical broadcast channel (SS/PBCH) blocks.

The measurement results may comprise at least one of the following: layer 1 reference signal received power (L1-RSRP) measurement results or layer 1 signal to interference noise ratio (L1-SINR) measurement results.

The reporting setting configuration may provide a third higher layer parameter that provides the number of receiving units that are to be used to perform beam measurement.

The method may further comprise generating, by the terminal device, a beam report stating channel state information reference signal resource indicators (CRIs) or synchronization signal block resource indicators (SSBRIs), wherein the reporting setting configuration may provide a fourth higher layer parameter that provides the number of CRIs or SSBRIs in each beam report.

The reporting setting configuration may provide a fifth higher layer parameter that provides the number of reference signal resources that are to be reported for each receiving unit.

The method may further comprise transmitting, by the terminal device, one CRI or SSBRI, a plurality of measurement results, and one index that identifies the receiving unit that is used to measure the plurality of measurement results.

The terminal device may be configured with a first resource setting with a first number (N1) of reference signal resources and may be configured with a second resource setting with a second number (N2) of reference signal resources.

The method may further comprise generating, by the terminal device, a beam report stating two sets of CRIs or SSBRIs and corresponding measurement results.

The CRIs or SSBRIs in the first set may be selected from the reference signal resources in the first resource setting and the CRIs or SSBRIs in the second set may be selected from the reference signal resources in the second resource setting.

The first set of CRIs or SSBRIs may comprise 2×K reference signal resource indicators and the second set of CRIs or SSBRIs may comprise 2×K reference signal resource indicators, and wherein K CRIs or SSBRIs in the first set may be selected from the reference signal resources in the first resource setting and the other K CRIs or SSBRIs in the first set may be selected from the reference signal resources in the second resource setting.

The best beam for each receiving unit may be determined as the beam received by the receiving unit which has the best measurement result.

The best beam for each receiving unit may be determined as the beam received by the receiving unit which has the highest received power.

The terminal device may determine the at least one best beam received by each of the first and second receiving units.

The method may further comprise generating, by the terminal device, a beam report stating measurements of each beam labelled with the index, and transmitting the beam report for at least one of the first and second network devices.

The method may further comprise generating, by the terminal device, a beam report stating measurements of one or more selected beams labelled with the index, and transmitting the beam report for at least one of the first and second network devices.

The method may further comprise controlling, by the at least one of the first and second network devices, each of the first and second network devices to transmit a specific beam to the terminal device based on the beam report.

The method may further comprise controlling the first network device to transmit the determined best beam received by the first receiving unit, and controlling the second network device to transmit the determined best beam received by the second receiving unit.

The method may further comprise receiving, by the first receiving unit, only at least one first beam transmitted by the first network device, and receiving, by the second receiving unit, only at least one second beam transmitted by the second network device.

The first receiving unit may be configured to receive a first set of reference signal resources and the second receiving unit may be configured to receive a second set of reference signal resources.

The method may further comprise measuring, by the terminal device, beams using one particular receiving unit configured by at least one of the first and second network devices.

The method may further comprise transmitting, by the terminal device, the number of receiving units that would be used to perform beam measurement.

The first receiving unit may be a receiving panel or a subset of receiving panels and the second receiving unit may be a receiving panel or a subset of receiving panels.

According to embodiments, there is also provided a terminal device comprising: a first receiving unit configured to receive at least one beam transmitted by at least one of a first network device and a second network device, a second receiving unit configured to receive at least one beam transmitted by at least one of the first network device and the second network device, and a processing unit arranged to measure each beam received by the first and second receiving units and generate a beam report stating the measurement results of at least one beam.

The processing unit may be configured to determine the at least one best beam received by the first receiving unit and determine the at least one best beam received by the second receiving unit, and wherein the beam report may state the at least one best beam received by each receiving unit.

The terminal device may further comprising a transmitting unit configured to transmit the beam report.

The processing unit may be configured with a reporting setting configuration to control the terminal device to obtain receiving unit specific measurement results for reference signal resources of each beam.

The reporting setting configuration may be provided by an information element with a first higher layer parameter set to a first value to control the terminal device to obtain receiving unit specific measurement results for reference signal resources of each beam.

The reporting setting configuration may provide a second higher layer parameter that provides an index for one of at least one receiving unit.

The reference signal resources may comprise at least one of the following: channel state information reference signal (CSI-RS) resources or synchronization signal block (SSB) resources or synchronization signal/physical broadcast channel (SS/PBCH) blocks.

The measurement results may comprise at least one of the following: layer 1 reference signal received power (L1-RSRP) measurement results or layer 1 signal to interference noise ratio (L1-SINR) measurement results.

The reporting setting configuration may provide a third higher layer parameter that provides the number of receiving units that are to be used to perform beam measurement.

The beam report may state channel state information reference signal resource indicators (CRIs) or synchronization signal block resource indicators (SSBRIs), wherein the reporting setting configuration may provide a fourth higher layer parameter that provides the number of CRIs or SSBRIs in each beam report.

The reporting setting configuration may provide a fifth higher layer parameter that provides the number of reference signal resources that are to be measured using each receiving unit.

The beam report may state one CRI or SSBRI, a plurality of measurement results, and one index that identifies the receiving unit that is used to measure the plurality of measurement results.

The processing unit may be configured with a first resource setting with a first number (N1) of reference signal resources and is configured with a second resource setting with a second number (N2) of reference signal resources.

The beam report may state two sets of CRIs or SSBRIs and corresponding measurement results.

The processing unit may be configured to select the CRIs or SSBRIs in the first set from the reference signal resources in the first resource setting and to select the CRIs or SSBRIs in the second set from the reference signal resources in the second resource setting.

The first set of CRIs or SSBRIs may comprise 2×K reference signal resource indicators and the second set of CRIs or SSBRIs may comprise 2×K reference signal resource indicators, and wherein the processing unit may be configured to select K CRIs or SSBRIs in the first set from the reference signal resources in the first resource setting and to select the other K CRIs or SSBRIs in the first set from the reference signal resources in the second resource setting.

The processing unit may be configured to determine the best beam for each receiving unit as the beam received by the receiving unit which has the best measurement result.

The processing unit may be configured to determine the best beam for each receiving unit as the beam received by the receiving unit which has the highest received power.

The beam report may state measurement results of each beam labelled with the index, and wherein the terminal device may further comprise a transmitting unit configured to transmit the beam report for at least one of the first and second network devices.

At least one of the first and second receiving units may be configured to receive configuration information from at least one of the first and second network devices, and wherein the processing unit may be arranged to be configured based on the configuration information.

The beam report may state measurement results of one or more selected beams labelled with the index, and wherein the terminal device may further comprise a transmitting unit configured to transmit the beam report for at least one of the first and second network devices.

The first receiving unit may be configured to only measure at least one first beam transmitted by the first network device, and the second receiving unit may be configured to only measure at least one second beam transmitted by the second network device.

The processing unit may be configured to measure beams using one particular receiving unit.

The terminal device may further comprise a transmitting unit configured to transmit the number of receiving units that would be used to perform beam measurement.

The first receiving unit may be configured to receive a first set of reference signal resources and the second receiving unit may be configured to receive a second set of reference signal resources.

The first receiving unit may be configured to only receive at least one first beam transmitted by the first network device, and the second receiving unit may be configured to only receive at least one second beam transmitted by the second network device.

The first receiving unit may be a receiving panel or a subset of receiving panels and the second receiving unit may be a receiving panel or a subset of receiving panels.

According to embodiments, there is also provided a network device comprising: a communication unit configured to communicate with a terminal device, and a processing unit configured to control the communication unit to transmit configuration information to configure the terminal device to measure a first beam transmitted by a first network device and to measure a second beam transmitted by a second network device.

The communication unit may be configured to receive a beam report from the terminal device, and the processing unit may be configured determine the at least one best beam received by each of a first receiving unit and a second receiving unit of the terminal device.

The configuration information may be to configure the terminal device to obtain receiving unit specific measurement results for reference signal resources of each beam.

The communication unit may be configured to transmit the best beam to be received by the first receiving unit and may be configured to transmit the best beam to be received by the second receiving unit.

According to embodiments, there is also provided a computer-readable medium having computer-executable instructions to cause one or more processors of a computing device to carry out the method of any one of the embodiments.

### BRIEF DESCRIPTION OF THE DRAWINGS

Embodiments will now be described, by way of example only, with reference to the accompanying drawings, in which:

FIG. 1 shows a schematic illustration of a system according to an embodiment;

FIG. 2 shows a schematic illustration of a terminal device according to an embodiment;

FIG. 3 shows schematic illustration of a network device according to an embodiment;

FIG. 4 shows a flowchart of the operation of the terminal device according to an embodiment;

FIG. 5 shows a flowchart of the operation of the terminal device according to an embodiment; and

FIG. 6 shows a flowchart of the operation of the terminal device according to an embodiment;

FIG. 7 shows a flowchart of the operation of the network device according to an embodiment; and

FIG. 8 shows a flowchart operation of the system according to an embodiment.

### DETAILED DESCRIPTION

Technical solutions in the embodiments of the present application will be described clearly and completely below with reference to the accompanying drawings.

These technical solutions may be applied to a 5G NR communication system.

It is to be understood that these technical solutions may also be applied to various communication systems, for example, a Global System Mobile communication (GSM), a Code Division Multiple Access (CDMA) system, a Wideband Code Division Multiple Access (WCDMA) system, a General Packet Radio Service (GPRS) system, a Long Term Evolution (LTE) system, an LTE Frequency Division Duplex (FDD) system, an LTE Time Division Duplex (TDD) system, a Universal Mobile Telecommunication System (UMTS), a Worldwide Interoperability for Microwave Access (WiMAX) communication system, and New Radio (NR) or future 5G systems, and the like.

The technical solutions may be applied to a variety of orthogonal and non-orthogonal multiple access technology-based communication systems.

A terminal device in the embodiments may refer to a user equipment (UE), an access terminal, a subscriber unit, a subscriber station, a mobile station, a remote station, a remote terminal, a mobile device, a user terminal, a terminal, a wireless communication device, a user agent, or a user apparatus. The access terminal may be a cellular phone, a cordless phone, an SIP (Session Initiation Protocol) phone, a WLL (Wireless Local Loop) station, a PDA (Personal Digital Assistant), a handheld device having a wireless communication function, a computing device, or another processing device connected to a wireless modem, a vehicle-mounted device, a wearable device, a terminal device in a future 5G network, or a terminal device in a future evolutional PLMN (Public Land Mobile Network), and the like. However, the embodiments of the present application are not limited thereto.

A network device in the embodiments of the present application may be a device for communicating with the terminal device. Specifically, the network device may be a Base Transceiver Station (BTS) in a GSM system or a CDMA system, a NodeB (NB) in a WCDMA system, an Evolutional NodeB (eNB or eNodeB) in an LTE system, a wireless controller, or a relay station, an access point, a vehicle-mounted device, a wearable device, a network device in 5G network (for example, gNB), or a network device in a future evolutional Public Land Mobile Network (PLMN), etc. The network device may be a transmission-reception point (TRP) of a base station (for example, a gNB). However, the embodiments of the present application are not limited thereto.

A transmission point (TP) is a set of geographically co-located transmit antennas (e.g. antenna array (with one or more antenna elements)) for one cell or part of one cell. Transmission Points can include base station (ng-eNB or gNB) antennas, remote radio heads, a remote antenna of a base station, etc. One cell can include one or multiple transmission points. For a homogeneous deployment, each transmission point may correspond to one cell.

A reception point (RP) is a set of geographically co-located receive antennas (e.g. antenna array (with one or more antenna elements)) for one cell or part of one cell. Reception Points can include base station (ng-eNB or gNB) antennas, remote radio heads, a remote antenna of a base station, and so on. One cell can include one or multiple reception points. For a homogeneous deployment, each reception point may correspond to one cell.

A transmission-reception point (TRP) is a set of geographically co-located antennas (e.g. antenna array (with one or more antenna elements)) supporting TP and/or RP functionality.

A wireless communication network includes one or more fixed base infrastructure units forming a network distributed over a geographical region. As an example, the network device may serve a number of terminal devices within a serving area, for example, a cell, or within a cell sector. In some systems, one or more network devices are coupled to a controller (such as a wireless controller) forming an access network that is coupled to one or more core networks. Base stations (gNBs) are examples of network devices in the wireless network, the serving area of which may or may not overlap with each other.

A communication system in general may include a terminal device and a network device. The network device is configured to provide communication service for the terminal device and access to a core network. The terminal device accesses the network by searching a synchronous signal, broadcast signal and the like transmitted by the network device, thereby communicating with the network.

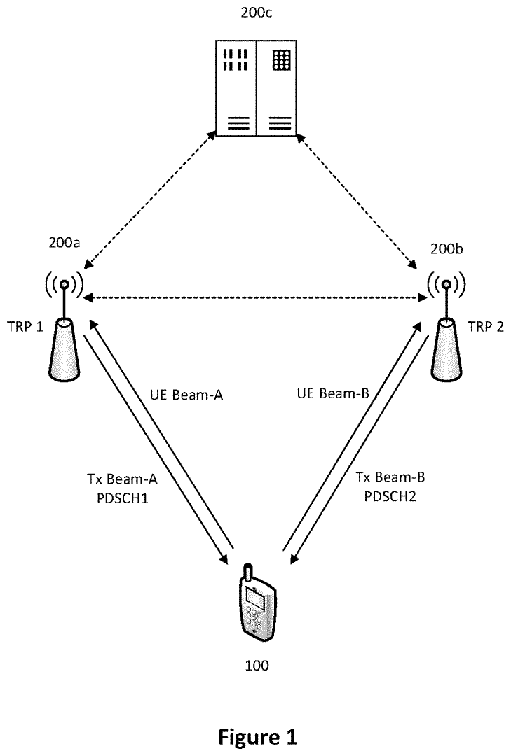

FIG. 1 shows a schematic illustration of a communication system 10 according to an embodiment.

The system 10 comprises a terminal device 100, a first network device 200a, and a second network device 200b. Each of the first and second network devices 200a, 200b comprises a transmission-reception point (TRP). The first and second network devices 200a, 200b may each be a TRP of a base station (gNB). The terminal device 100 is in communication with the first network device 200a and the second network device 200b. The first and second network devices 200a, 200b may each be connected to a third network device 200c. For example, the third network device 200c may be a wireless controller. The first and second network devices 200a, 200b may be connected to one another to enable direct communication between the first network device 200a and the second network device 200b. The connection may be a wired or wireless connection.

As an example, the terminal device 100 shown in FIG. 1 is in the serving area covered by the transmission-reception point (TRP) of the first network device 200a and the transmission-reception point (TRP) of the second network device 200b. The terminal device 100 is connected with the first network device 200a via a first wireless link and is connected with the second network device 200b via a second wireless link. A third network device 200c, such as a wireless controller, may be connected to the first and second network devices 200a and 200b. According to an embodiment, the terminal device 100 is equipped and configured to be able to connect with the first and second network devices 200a, 200b simultaneously.

As shown in FIG. 1, the terminal device 100 and the first and second network devices 200a, 200b can perform uplink transmission (terminal device 100 to network device 200) and downlink transmission (network device 200 to terminal device 100).

FIG. 1 exemplarily shows three network devices 200 and one terminal device 100. However, embodiments are not limited to this, and the wireless communication system 10 may include a plurality of network devices 200, and the coverage of each network device 200 may include any number of terminal devices 100.

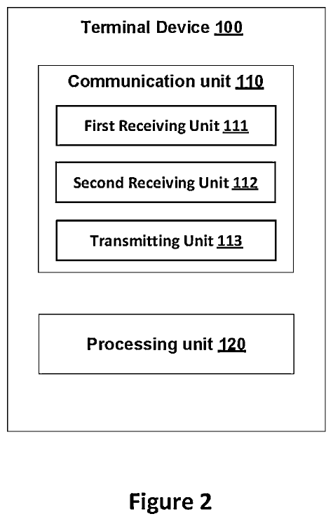

FIG. 2 shows a schematic illustration of the terminal device 100 of the communication system 10 of FIG. 1. As shown in FIG. 2, the terminal device 100 includes a communication unit 110 comprising a first receiving unit 111 and a second receiving unit 112. The communication unit 110 may further include a transmitting unit 113 and the terminal device 100 may further include a processing unit 120.

The communication unit 110 is configured to communicate with the network device 200. More specifically, the communication unit 110 is configured to perform both uplink communication (i.e. terminal device 100 to network device 200) and downlink communication (i.e. network device 200 to terminal device 100).

The first and second receiving units 111, 112 are arranged to receive a reference signal. The first receiving unit 111 may be configured to receive a first set of reference signal resources and the second receiving unit 112 may be configured to receive a second set of reference signal resources.

The first and second receiving units 111, 112 may each be a receiving panel or a subset of receiving panels. A receiving panel or receiving panel subset may include a group of physical antennas, and each panel may be able to receive signals on an independent radio frequency channel.

The terminal device 100 may be configured with a first resource setting to measure reference signal resources within the first set of reference signal resources. The terminal device 100 may also be configured with a second resource setting to measure reference signal resources within the second set of reference signal resources. The first resource setting may be for channel measurement on Synchronization Signal Block (SSB) or NZP CSI-RS resources for L1-RSRP computation and the second resource setting may be for channel measurement on SSB or NZP CSI-RS resources for L1-RSRP computation.

The transmitting unit 113 may transmit information, such as a configuration report, beam report or any other information, to at least one of the first network device 200a and the second network device 200b by transmitting a beam as shown in FIG. 1.

A configuration report states configuration information of the terminal device 100.

A beam report states at least one measurement result of at least one received beam.

The processing unit 120 is configured to control the overall functionality of the terminal device 100, including that of the communication unit 110. This includes controlling the communication unit 110 to perform both uplink and downlink communications, as well as processing signals received through the downlink transmissions.

The processing unit 120 may be configured to measure the reference signal resources within the resource setting(s) of the terminal device 100 using the receiving units 111, 112. For example, the processing unit 120 may measure a reference signal resource (such as a CSI-RS resource or SS/PBCH block) and generate a corresponding reference signal resource indicator (such as a CRI or SSBRI).

The processing unit 120 may be configured to control the transmitting unit 113 to transmit information, such as a beam report, to at least one of the first and second network devices 200a, 200b. However the transmission is not limited to the first and second network devices and may be to any network device.

The processing unit 120 may be configured such that the terminal device is able to measure and report receiving unit specific measurement results on reference signal resources. The processing unit 120 may be configured to state a value of measurement reporting groups which is the number of receiving units that the terminal device 100 can use to obtain measurement results. The processing unit 120 may be configured to state a value of the number of reported reference signal resource indicators that indicates the number of reference signal resource indicators (such as CRI or SSBRI) that the terminal device 100 can report for each receiving unit. The processing unit 120 may be configured such that the terminal device 100 is able to receive downlink transmission of the first set of reference signal resources and the second set of reference signal resources on overlapped OFDM symbols (i.e. simultaneously).

Referring to FIGS. 1 and 2, the terminal device 100 receives a first beam transmitted from the first network device 200a and receives a second beam transmitted from the second network device 200b. Each of the first and second beams may be Physical Downlink Shared Channel (PDSCH) transmissions. PDSCH is a physical channel that carries data. The first network device 200a may use transmission (Tx) beam-A to transmit information, on a first channel (PDSCH 1), to the terminal device 100 while the second network device 200b may use Tx beam-B to transmit information, on a second channel (PDSCH 2), to the terminal device 100.

Although the terminal device 100 includes a first and second receiving unit in the present embodiment, the embodiments of the present application are not limited thereto. The terminal device 100 includes at least one receiving unit such as a receiving panel. The terminal device 100 may have multiple receive panels and, on each panel, the terminal device 100 can implement one or multiple different receive (Rx) beam directions. However, on each panel, the terminal device 100 can only formulate one Rx beam direction at one time while the terminal device 100 can formulate different Rx beam directions on multiple Rx panels. In the example shown in FIG. 1, the terminal device 100 uses one Rx panel to measure Tx beam-A and use another Rx panel to measure Tx beam-B to receive the PDSCH 1 and PDSCH 2 transmission from the two network devices 200a, 200b.

The PDSCH 1 and PDSCH 2 transmissions can be fully, partially or not overlapped in time domain. When the PDSCH 1 and PDSCH 2 transmissions are fully or partially overlapped in the time domain, on the OFDM symbols where both PDSCH 1 and PDSCH 2 are transmitted, the terminal device 100 receives the signals transmitted by both Tx beam-A and Tx beam-B simultaneously. Based on beam training, the terminal device 100 pairs a first received beam with Tx beam-A and a second received beam with Tx beam-B.

To enable the terminal device 100 to receive signals transmitted by Tx beam-A and Tx beam-B on one same symbol, the terminal device 100 uses the first receiving unit 111 and the second receiving unit 112 on the same symbol, i.e., simultaneously.

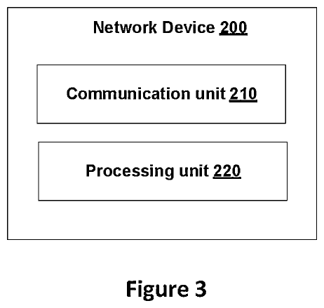

FIG. 3 shows a schematic illustration of the network device 200 of the communication system 10 of FIG. 1. As shown in FIG. 3, the network device 200 comprises a communication unit 210 and a processing unit 220.

The communication unit 210 is configured to communicate with the terminal device 100. More specifically, the communication unit 210 is configured to perform both uplink communication (i.e. terminal device 100 to network device 200) and downlink communication (i.e. network device 200 to terminal device 100). The communication unit 210 may be configured to transmit a beam using a first set of reference signal resources or a second set of reference signal resources. The communication unit 210 may be configured to transmit downlink control information (DCI) and/or Radio Resource Control (RRC) configuration information to configure the terminal device 100.

The processing unit 220 is configured to control the overall functionality of the network device 200, including that of the communication unit 210. This includes controlling the communication unit 210 to perform both uplink and downlink communications, as well as processing signals received through the uplink transmissions. The processing unit 220 may be configured to control which set of reference signal resources are transmitted by the communication unit 210.

In group-based L1-RSRP beam reporting, the terminal device 100 may be configured with a resource setting for channel measurement that contains a set of non-zero power (NZP) CSI-RS resources or SS/PBCH blocks. Each NZP CSI-RS resource or SS/PBCH block is used to represent one network device (gNB) 200 transmit beam. The terminal device 100 is configured to measure the L1-RSRP of those NZP CSI-RS resources or SS/PBCH blocks. Then the terminal device 100 may report two CSI-RS Resource Indicators (CRIs) or SS/PBCH Resource Block Indicators (SSBRIs) for two selected NZP CSI-RS resources or SS/PBCH blocks for which the terminal device 100 is able to use a single spatial domain receive filter or multiple simultaneous spatial domain receive filters.

For Layer 1 Signal to Interference Noise Ratio (L1-SINR) based beam measurement and reporting, the terminal device 100 may be configured with one of the following resource setting configurations:
The terminal device 100 is configured with one resource setting with a set of NZP CSI-RS resources for channel measurement and interference measurement, or
The terminal device 100 is configured with two resource settings. The first resource setting has a set of NZP CSI-RS resources or SS/PBCH blocks for channel measurements and the second resource setting has a set of NZP CSI-RS resources or ZP CSI-RS resources for interference measurement.

For L1-SINR beam report, the terminal device 100 may report up to 4 CRIs or SSBRIs and the corresponding L1-SINR measurement results. Group-based beam reporting of L1-SINR is also supported, in which the terminal device 100 may report up to 2 CRIs or SSBRIs and the corresponding L1-SINR measurement results.

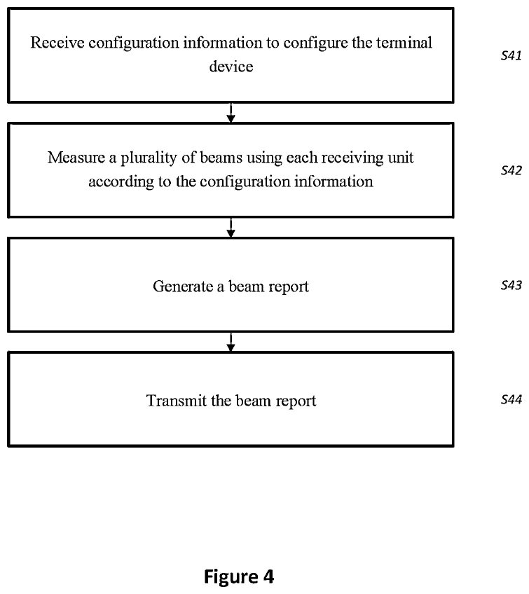

FIG. 4 shows a flowchart of the operation of the terminal device 100 of FIG. 2. Through the flowchart of FIG. 4 discussed below, the terminal device 100 can be configured to measure multiple beams from different transmission-reception points and report the at least one best beam for each receiving unit.

At step S41 of FIG. 4, the terminal device 100 receives configuration information to configure the terminal device 100.

The terminal device 100 may be configured with a reporting setting configuration with a higher layer parameter set to control the terminal device 100 to measure and report receiver unit specific beam measurements. The higher layer parameter may be a Radio Resource Control (RRC) parameter. However, embodiments are not limited to this, and alternative higher layer (i.e. higher than the physical layer) parameters can be used instead.

The reporting setting configuration may be generated by any one of the first, second and third network devices 200a, 200b, 200c and transmitted to the terminal device 100 by at least one of the first and second network devices 200a, 200b. The reporting setting configuration of the terminal device 100 may be set by transmitting downlink control information (DCI) and/or RRC configuration information from at least one of the first and second network devices 200a, 200b to the terminal device 100.

As an example, the terminal device 100 may be configured with an information element, such as CSI-ReportConfig (that provides the reporting setting configuration), with a higher layer parameter to control the terminal device 100 to measure and report receiving unit specific L1-RSRP of a set of CSI-RS resources or SS/PBCH blocks. For example, the higher layer parameter may be reportQuantity set to cri-perpanel-RSRP′ or ssbri-perpanel-RSRP′ to control the terminal device 100 to measure and report receiving unit specific L1-RSRP of a set of CSI-RS resources or SS/PBCH blocks.

The terminal device 100 is configured with a number of receiving units which are each able to measure received beams. The number of receiving units which are each able to measure received beams is set by the reporting setting configuration of the terminal device 100.

The reporting setting configuration provides a value of L1-RSRP reporting groups, i.e., the number of receiving units (panels or panel subsets) that can be used to report L1-RSRP. For this function, the terminal device 100 is configured with an information element, such as CSI-ReportConfig (that provides the reporting setting configuration), with the higher layer parameter, such as reportNumber, that is used to indicate the number of reporting groups. The value of reportNumber may be 1, 2, or 4 but the value is not limited to these specific examples and may be any positive integer.

The processing unit 120 is able to report a set number of beams for each receiving unit of the terminal device 100.

The reporting setting configuration of the terminal device 100 provides a value of number of reported CRIs/SSBRIs, nrofReportedRS, that indicates the number of CRI or SSBRI (received beams) the terminal device 100 can report for each receiving unit (Rx panel or Rx panel subset). In other words, a higher layer parameter of the terminal device 100 is set to define the number of beams that can be reported by each receiving unit.

The terminal device 100 may be configured by receiving information, such as downlink control information (DCI) and/or RRC configuration information, from a network device 200. For example, the communication unit 110 may receive a communication from a network device 200 comprising instructions. The processing unit 120 may follow the instructions to configure the terminal device 100.

Downlink control information (DCI) provides the terminal device 100 with information such as physical layer (Layer 1) resource allocation and power control commands for both uplink and downlink transmission. DCI is transmitted on the Physical Downlink Control Channel (PDCCH) with 24-bit cyclic redundancy check (CRC) attachment. There are multiple DCI formats defined to meet different needs.

The reporting setting configuration can provide a higher layer parameter, such as indexRxPanel, that provides an index of the receiving unit (Rx panel or Rx panel subset) to indicate that the terminal device 100 can use the indicated receiving unit (Rx panel or Rx panel subset) to measure the L1-RSRP of the CSI-RS resources or SS/PBCH blocks and then report the measurement results.

At step S42 of FIG. 4, the terminal device 100 measures a plurality of beams using each receiving unit 111, 112 of the terminal device 100.

The terminal device 100 may be configured to measure each beam transmitted from each of a plurality of network devices 200 using each of a plurality of receiving units of the terminal device 100. In other words, each receiving unit of the terminal device 100 may be used to measure each beam transmitted from a plurality of network devices 200. Each network device 200 may transmit a plurality of beams which comprise different sets of reference signal resources.

At step S43 of FIG. 4, the terminal device 100 generates a beam report containing the measurement results of each beam with respect to each receiving unit.

The terminal device 100 may generate a beam report including the measurements of each beam received by each receiving unit of the terminal device 100. To identify the measured beams received by a specific receiving unit, the terminal device 100 may be configured to assign an index to each receiving unit. The index is included within the beam report to provide receiver unit specific beam measurements.

At step S44 of FIG. 4, the terminal device 100 transmits the beam report. In particular, the processing unit 120 may control the transmitting unit 113 to transmit the beam report to a network device 200. The information on the direction in which to transmit a beam from the terminal device 100 to at least one of the network devices 200 may be contained within any previous downlink transmission received by the terminal device 100.

The beam report may be used to identify the at least one best beam received by each receiving unit 111, 112. The best beam may be the received beam with the highest received power. The best beam may be the received beam with the highest signal to interference noise ratio. However, the at least one best beam may be determined using any measurement metric and is not limited to the above examples. The measurement metric may be set by Radio Resource Control (RRC) configuration information generated by a network device 200 and transmitted to the terminal device 100.

The processing unit 120 may follow instructions within a communication from the network device 200 to measure a first beam transmitted by the first network device 200a and measure a second beam transmitted by the second network device 200b.

The first and second network devices 200a, 200b may be configured such that the first beam comprises reference signal resources included within a first set of reference signal resources and the second beam comprises reference signal resources included within a second set of reference signal resources. Therefore, the processing unit 120 may use the first receiving unit to measure reference signal resources in the first reference signal resource set and use the second receiving unit 112 to measure reference signal resources in the second reference signal resource set.

The reference signal resources may be CSI-RS or SSB resources or SS/PBCH blocks.

The first and second network devices 200a, 200b may each be a TRP of a gNB. For example, the first network device 200a may be a first TRP of a gNB and the second network device 200b may be a second TRP of the gNB. The first and second network devices 200a, 200b may be configured by a third network 200c device connected to both the first and second network devices 200a, 200b. Alternatively, at least one of the processing units 210 of the first and second network devices 200a, 200b may control the first and second network devices 200a, 200b to transmit the first beam comprising the first set of reference signal resources and the second beam comprising the second set of reference signal resources, respectively. In this case the first network device 200a and the second network device 200b may be in communication with each other.

The at least one best beam may be determined, based on the beam report, by the terminal device 100 or a network device 200 that receives the beam report.

In the example shown in FIGS. 1 and 4, to support multi-TRP transmission from a first network device 200a and a second network device 200b, the terminal device 100 measures the transmission (Tx) beam of the first network device 200a with each receiving unit (Rx panel) and also measures the Tx beam of the second network device 200b with each receiving unit (Rx panel). The terminal device 100 reports the measurement results of the Tx beam of each of the first and second network devices 200a, 200b with respect to each receiving unit (Rx panel or Rx panel subset) of the terminal device 100 to a network device 200 such as at least one of the first and second network devices 200a, 200b. In particular, the terminal device 100 generates a beam report and transmits the beam report to a network device such as at least one of the first and second network devices 200a, 200b.

A third network device 200c (such as a gNB) may be connected to the first and second network devices 200a, 200b (which may each be a TRP of the gNB). The third network device 200c may receive the beam report via at least one of the first and second network devices 200a, 200b. Then the third network device (gNB) 200c may select one Tx beam-A of the first network device 200a that would be best received by the terminal device 100 with a first receiving unit 111 and select one Tx beam-B of the second network device 200b that would be best received by the terminal device 100 with a second receiving unit 112. The third network device 200c may then configure the first and second network devices 200a, 200b such that the first receiving unit 111 receives the at least one best beam to be received by the first receiving unit 111 and the second receiving unit 112 receives the at least one best beam to be received by the second receiving unit 112.

Alternatively, the at least one of the first network device 200a and the second network device 200b that receives the beam report may use the beam report to determine which at least one transmission beam is best for each receiving unit of the terminal device 100.

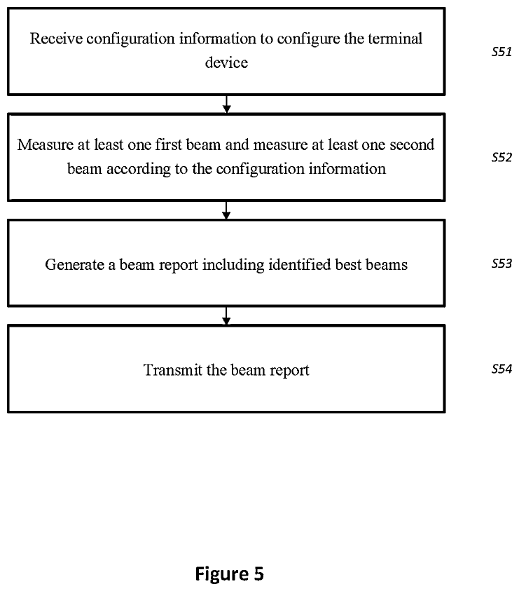

FIG. 5 shows a flowchart of the operation of the terminal device 100 of FIG. 2 according to another embodiment.

At step S51 of FIG. 5, which corresponds to step S41 of FIG. 4, the terminal device 100 receives configuration information to configure the terminal device 100.

A network device 200 may pre-configure the higher layer parameters of the terminal device 100 and communicate the configuration to the terminal device 100 through higher layer signalling such as Radio Resource Control (RRC). Or the configuration of the terminal device 100 may be predetermined in a protocol. There are no limits made thereto in the embodiments of the application.

At step S52 of FIG. 5, the terminal device 100 measures at least one first beam transmitted from a first network device 200a using the first receiving unit 111 and measures at least one second beam transmitted from the second network device 200b using a second receiving unit 112.

First beams are beams transmitted from the first network device 200a and second beams are beams transmitted from the second network device 200b.

In this embodiment, the terminal device 100 has been configured to use the first receiving unit 111 to measure reference signal resources included in first beams transmitted from the first network device 200a. The terminal device 100 has also been configured to use the second receiving unit 112 to measure reference signal resources included in second beams transmitted from the second network device 200b.

At step S53 of FIG. 5, the terminal device 100 generates a beam report containing the measurement results of each first beam received by the first receiving unit 111 and each second beam received by the second receiving unit 112. The terminal device 100 also identifies the at least one best first beam of the first network device 200a received by the first receiving unit 111 and identifies the at least one best second beam of the second network device 200b received by the second receiving unit 112. The terminal device 100 includes the information on the identified at least one best beam of the first and second network devices 200a, 200b received by the first and second receiving units 111, 112, respectively, within the beam report.

The best beam may be the received beam with the highest received power. The best beam may be the received beam with the highest signal to interference noise ratio. However, the at least one best beam may be determined using any measurement metric and is not limited to the above examples.

At step S54 of FIG. 5, the terminal device 100 transmits the beam report. In particular, the processing unit 120 may control the transmitting unit 113 to transmit the beam report to a network device 200 such as at least one of the first and second network devices 200a, 200b. The information on the direction in which to transmit a beam from the terminal device 100 to at least one of the network devices 200 may be contained within, or derived from, any previous downlink transmission received by the terminal device 100.

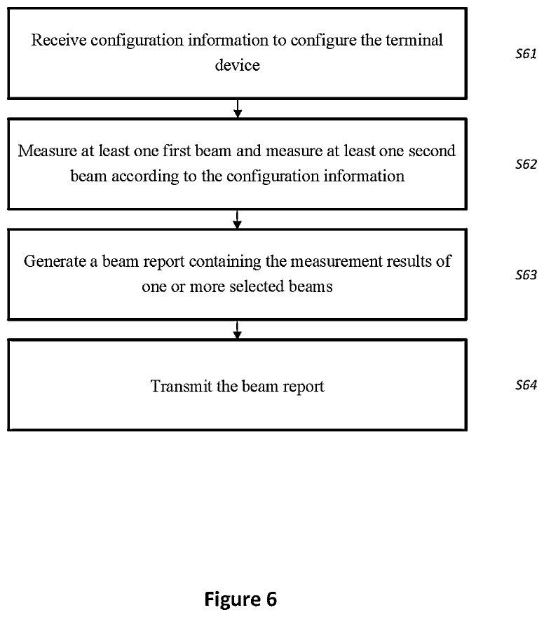

FIG. 6 shows a flowchart of the operation of the terminal device 100 of FIG. 2 according to another embodiment.

At step S61 of FIG. 6, which corresponds to step S41 of FIG. 4, the terminal device 100 receives configuration information to configure the terminal device 100.

At step S62 of FIG. 6, the terminal device 100 measures at least one beam transmitted from a first network device 200a and measures at least one beam transmitted from a second network device 200b using each receiving unit 111, 112 of the terminal device 100.

At step S63 of FIG. 6, the terminal device 100 generates a beam report containing the measurement results of one of more selected beams with respect to each receiving unit. The beams may be selected by the terminal device 100 based on the received power or the signal to interference noise ration of the beams. For example, beams with a received power above a predetermined first threshold and/or beams with a received signal to noise interference ratio above a predetermined second threshold are selected.

At step S64 of FIG. 6, the terminal device 100 transmits the beam report. In particular, the processing unit 120 may control the transmitting unit 113 to transmit the beam report to a network device 200 such as at least one of the first and second network devices 200a, 200b. The information on the direction in which to transmit a beam from the terminal device 100 to at least one of the network devices 200 may be contained within any previous downlink transmission received by the terminal device 100.

As described above, for the system 10 of FIG. 1, the beam measurement and reporting illustrated in any one of FIGS. 4 to 6 may be used to support more efficient beam selection.

As shown in FIG. 4, the terminal device 100 measures the Tx beams of each network device 200 with each receiving unit (Rx panel or Rx panel subset) individually and then reports the at least one ‘best’ Tx beam of each network device 200 for each receiving unit (Rx panel or Rx panel subset). Based on such reports, for Multi-TRP transmission, at least one network device 200 (such as a gNB) can choose one Tx beam of the first network device 200a which is a ‘best’ beam that is received by one receiving unit (Rx panel or Rx panel subset) and choose one Tx beam of the second network device 200b which is a ‘best’ beam that is received by another receiving unit (Rx panel or Rx panel subset).

As shown in FIG. 5, the terminal device 100 uses a first receiving unit (Rx panel or Rx panel subset) 111 to measure Tx beams of the first network device 200a and uses a second receiving unit (Rx panel or Rx panel subset) 112 to measure Tx beams of the second network device 200b. And then the terminal device 100 reports the at least one ‘best’ Tx beams of the first network device 200a that are received by the first receiving unit (Rx panel or Rx panel subset) 111 and the at least one ‘best’ Tx beams of the second network device 200b that are received by the second receiving unit (Rx panel or Rx panel subset) 112.

As shown in FIG. 6, the terminal device 100 uses each receiving unit (Rx panel or Rx panel subset) to measure multiple Tx beams from the first and second network devices 200a, 200b and then for each receiving unit (Rx panel or Rx panel subset), the terminal device 100 reports one or more selected Tx beams for each network device 200.

The third network device 200c (such as a gNB) may control the terminal device 100 to measure Tx beams with one particular receiving unit (Rx panel or Rx panel subset). In particular, the third network device 200c may control at least one of the first and second network devices 200a, 200b to transmit control information to the terminal device 100 to configure the terminal device 100.

Alternatively, the first and second network devices 200a, 200b may communicate with each other to generate and transmit control information to the terminal device 100 to configure the terminal device 100.

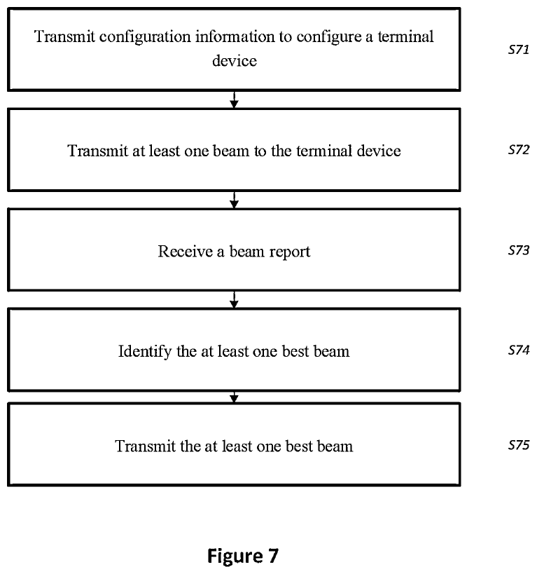

FIG. 7 shows a flowchart of the operation of the network device 200 of FIG. 3. The flowchart of FIG. 7 showing the operations of the network device 200 generally corresponds to the flowchart of FIGS. 4 to 6, but from the perspective of the network device 200, and corresponding considerations apply.

Through the flowchart of FIG. 7 discussed below, the network device 200 be configured to transmit the best beam to be received by a receiving unit of the terminal device 100.

At step S71 of FIG. 7, at least one of the first and second network devices 200a, 200b transmits configuration information to configure the terminal device 100.

As an example, any of the first, second and third network devices 200 may generate the configuration information to configure the terminal device 100. The third network device 200c may generate the information to configure the terminal device 100 and control the at least one of the first and second network devices 200a, 200b to transmit the configuration information to the terminal device 100.

At step S72 of FIG. 7, each of the first network device 200a and the second network device 200b transmits at least one beam to the terminal device 100.

Each network device 200 may be configured to transmit beams comprising a certain set of reference signal resources.

In particular, the processing unit 220 of each network device 200 may control the communication unit 210 of the network device 200 to transmit beams comprising a certain set of reference signal resources.

At step S73 of FIG. 7, at least one of the first and second network devices 200a, 200b receives a beam report stating the measurement results of each beam. The communication unit 210 of the at least one of the first and second network devices 200a, 200b may receive the beam report from the terminal device 100. The communication unit 210 of the at least one of the first and second network devices 200a, 200b may transmit the beam report to the third network device 200c.

Each beam transmitted by the first network device 200a may be measured using both the first receiving unit 111 and the second receiving unit 112 of the terminal device 100, or may be measured using only one of the first receiving unit 111 and the second receiving unit 112. Each beam transmitted by the second network device 200b may be measured using both the first receiving unit 111 and the second receiving unit 112 of the terminal device 100, or may be measured using only one of the first receiving unit 111 and the second receiving unit 112.

The beam report may include an index associating each beam measurement result with the receiving unit of the terminal device 100 which was used to make the measurement.

At step S74 of FIG. 7, the at least one of the first and second network devices 200a, 200b that receives the beam report may identify the at least one best beam received by each receiving unit of the terminal device 100. In particular, the processing unit 210 of the network device 200 may analyse the beam report and determine the at least one best beam received by each receiving unit of the terminal device 100.

Alternatively, the beam report may be transmitted to the third network device 200c (by the at least one of the first and second network devices 200a, 200b that receives the beam report) and the processing unit 220 of the third network device 200c may analyse the beam report and determine the at least one best beam received by each receiving unit of the terminal device 100.

Alternatively, the beam report as transmitted by the terminal device 100 may include the identified at least one best beam received by each receiving unit of the terminal device 100.

At step S75 of FIG. 7, each of the first and second network devices 200a, 200b transmits the best beam to the terminal device 100. Each of the first and second network devices 200a, 200b may configure themselves to transmit the identified best beam to the terminal device 100. Alternatively, the third network device 200c or the terminal device 100 may transmit information to both the first and second network devices 200a, 200b to configure each of the first and second network devices 200a, 200b.

The above method enables a network device 200 to identify the best beam to transmit to a terminal device 100 so that the terminal device 100 can receive multiple beams simultaneously.

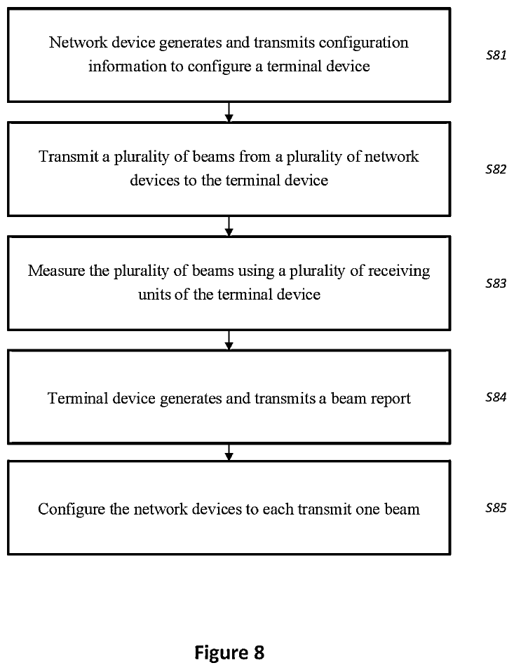

FIG. 8 is a schematic flowchart of a method for receiver unit specific beam reporting. The method may be applied to the system shown in FIG. 1, but is not limited thereto.

At step S81 of FIG. 8, a network device 200 generates and transmits configuration information to a terminal device 100.

At step S82 of FIG. 8, each network device 200 of a plurality of network devices 200 transmits at least one beam to the terminal device 100.

At step S83 of FIG. 8, each of the plurality of beams is measured by at least one of a plurality of receiving units of the terminal device 100.

At step S84 of FIG. 8, the terminal device 100 generates and transmits a beam report to at least one of a first and second network device 200a, 200b.

The beam report contains the beam measurement results for each receiving unit of the terminal device 100. The beam report may contain the identified at least one best beam for each receiving unit.

At step S85 of FIG. 8, each network device 200 may be configured to transmit its best beam identified based on the beam report.

As shown in FIGS. 4 to 6, the terminal device 100 may be configured to measure Tx beams of each network device 200 with each terminal device receiving unit (Rx panel or Rx panel subset) and then report the per-receiving unit (per-panel or per-panel subset) measurement results (for example L1-RSRP measurement, L1-SINR measurement) to a network device 200 such as at least one of the first and second network devices 200a, 200b. The first and second network devices 200a, 200b may transmit the beam report to the third network device 200c (such as a gNB) so that the third network device 200c can determine the at least one best beam to be received by each receiving unit. Alternatively, at least one of the first and second network devices 200a, 200b may determine the at least one best beam to be received by each receiving unit based on the beam report. The terminal device 100 may report the number of terminal device receiving units (Rx panels or Rx panel subsets) that would be used by the terminal device 100 in per-receiving unit (per-panel or per-panel subset) beam measurement and reporting (or called panel-specific beam measurement and reporting). Each receiving unit (Rx panel or each subset of Rx panels) can be equivalent to one set of spatial domain receive filters and those filters cannot be used by the terminal device 100 simultaneously on the same OFDM symbol.

The terminal device 100 may be configured with one resource setting with N CSI-RS resources or SS/PBCH blocks for channel measurement. The resource setting may be generated by at least one of the first, second and third network devices 200a, 200b, 200c and transmitted to the terminal device 100.

The terminal device 100 may be configured to report reportNumber sets of CRIs or SSBRIs and in each reported set, the terminal device 100 may report nrofReportedRS CRIs or SSBRIs.

The terminal device 100 may be configured to report, for each reported CRI or SSBRI, one L1-RSRP or differential L1-RSRP value. The L1-RSRP or differential L1-RSRP value reported for the CRI or SSBRI in one reporting set is measured with the receiving unit (Rx panel or Rx panel subset) that corresponds to the reporting set.

As another example, if the terminal device 100 is provided with higher layer parameter, indexRxPanel, the terminal device 100 may use the corresponding receiving unit (Rx panel or panel subset or set of spatial domain receive filters) to measure the CSI-RS resources or SS/PBCH blocks configured in the associated resource setting. The terminal device 100 may report the L1-RSRP or differential L1-RSRP measured through the receiving unit (Rx panel or Rx panel subset or set of spatial domain receive filters) that is indicated by the indexRxPanel.

As another example, the terminal device 100 is configured with one resource setting with N CSI-RS resources or SS/PBCH blocks for channel measurement.

The terminal device 100 may be configured to report a CRI or SSBRI, the L1-RSRP or differential L1-RSRP measurement of the reported CRI or SSBRI and an index to indicate the receiving unit (Rx panel or Rx panel subset or set of spatial domain receive filters) that is used to measure the reported L1-RSRP or differential L1-RSRP of the reported CRI or SSBRI.

The terminal device 100 may be configured to report one or more of the information of a CRI or SSBRI, L1-RSRP or differential L1-RSRP of the reported CRI or SSBRI, the index of the receiving unit (Rx panel or Rx panel subset or set of spatial domain receive filters) that is used to measure the reported L1-RSRP or differential L1-RSRP of the reported CRI or SSBRI.

According to another disclosed method, the terminal device 100 may be configured with two resource settings: a first resource setting with N1 CSI-RS resources or SS/PBCH blocks for channel measurement and a second resource setting with N2 CSI-RS resources or SS/PBCH blocks. The terminal device 100 may be configured to measure the L1-RSRP of those CSI-RS resources or SS/PBCH blocks and then, in one reporting instance, the terminal device 100 may report two sets of CRIs or SSBRIs and corresponding L1-RSRP or differential L1-RSRP measurement: a first set of K CRIs or SSBRIs and a second set of K CRIs or SSBRIs.

The reported CRI or SSBRI in the first set may be selected from reference signal resources in the first resource setting and the reported L1-RSRP or differential L1-RSRP may be measured with a first receiving unit (a first Rx panel or a first Rx panel subset or a first set of spatial domain receive filters). The CRI or SSBRI reported in the second set may be selected from reference signal resources in the second resource setting and the reported L1-RSRP or differential L1-RSRP may be measured with a second receiving unit (a second Rx panel or a second Rx panel subset or a second set of spatial domain receive filters).

According to another disclosed method, the terminal device 100 may be configured with two resource settings: a first resource setting with N1 CSI-RS resources or SS/PBCH blocks for channel measurement and a second resource setting with N2 CSI-RS resources or SS/PBCH blocks. The UE can be configured to measure the L1-RSRP of those CSI-RS resources or SS/PBCH blocks and then report, in one reporting instance, two sets of CRIs or SSBRIs and corresponding L1-RSRP or differential L1-RSRP measurement: a first set of 2×K CRIs or SSBRIs and a second set of 2×K CRIs or SSBRIs.

Among the 2×K CRIs or SSBRIs reported in the first set, K reported CRI or SSBRI in the first set may be selected from reference signal resources in the first resource setting and another K reported CRI or SSBRI in the first set may be selected from reference signal resources in the second resource setting and the reported L1-RSRP or differential L1-RSRP may be measured with a first receiving unit (a first Rx panel or a first Rx panel subset or a first set of spatial domain receive filters).

Among the 2×K CRIs or SSBRIs reported in the second set, K CRI or SSBRI reported in the second set may be selected from reference signal resources in the first resource setting and another K CRI or SSBRI reported in the second set may be selected from reference signal resources in the second resource setting and the reported L1-RSRP or differential L1-RSRP may be measured with a second receiving unit (a second Rx panel or a second Rx panel subset or a second set of spatial domain receive filters).

In summary, the present disclosure provides methods for receiving unit specific beam measurement and reporting:

One terminal device 100 may measure L1-RSRP of a set of NZP CSI-RS resources or SS/PBCH blocks with each terminal device receiving unit (receive panel or each subset of terminal device receive panels).

The terminal device 100 may report one reference signal resource indicator (CRI or SSBRI), the measurement results (such as L1-RSRP measurement results) and one ID that is used to identify the terminal device receiving unit (receive panel or the subset of terminal device receive panels) that is used by the terminal device 100 to measure the reported measurement.

In one report instance, the terminal device 100 may report L1-RSRP measurement results for each terminal device receiving unit (receive panel or each subset of receive panels). In one report instance, the terminal device 100 may report one or more CRIs or SSBRIs and corresponding L1-RSRP measurement results for each terminal device receiving unit (receive panel or each subset of receive panels).

The terminal device 100 may report one or more CRI or SSBRI and corresponding L1-RSRP measurement results for the same terminal device receiving unit (receive panel or the same subset of receive panels) that is used by the terminal device 100 to measure the reported L1-RSRP measurement.

The terminal device 100 may report one CRI or SSBRI and the L1-RSRP measurement results for the reported CRI or SSBRI that is measured on each terminal device receiving unit (receive panel or each subset of the receive panels).

Embodiments can also provide a computer-readable medium having computer-executable instructions to cause one or more processors of a computing device to carry out the method of any of the embodiments.

Examples of computer-readable media include both volatile and non-volatile media, removable and non-removable media, and include, but are not limited to: solid state memories; removable disks; hard disk drives; magnetic media; and optical disks. In general, the computer-readable media include any type of medium suitable for storing, encoding, or carrying a series of instructions executable by one or more computers to perform any one or more of the processes and features described herein.

It will be appreciated that the functionality of each of the components discussed can be combined in a number of ways other than those discussed in the foregoing description. For example, in some embodiments, the functionality of more than one of the discussed devices can be incorporated into a single device. In other embodiments, the functionality of at least one of the devices discussed can be split into a plurality of separate (or distributed) devices.

Conditional language such as “may”, is generally used to indicate that features/steps are used in a particular embodiment, but that alternative embodiments may include alternative features, or omit such features altogether.

Furthermore, the method steps are not limited to the particular sequences described, and it will be appreciated that these can be combined in any other appropriate sequences. In some embodiments, this may result in some method steps being performed in parallel. In addition, in some embodiments, particular method steps may also be omitted altogether.

While certain embodiments have been discussed, it will be appreciated that these are used to exemplify the overall teaching of the present disclosure, and that various modifications can be made without departing from the scope of the disclosure.

Many further variations and modifications will suggest themselves to those versed in the art upon making reference to the foregoing illustrative embodiments, which are given by way of example only, and which are not intended to limit the scope of the disclosure, that being determined by the appended claims and their equivalents.

What is claimed is:

1. A method for performing reference signal resource measurement, the method comprising:
measuring at least one reference signal resource transmitted by at least one of a first network device and a second network device, and received by a first receiving unit of a terminal device;
measuring at least one reference signal resource transmitted by at least one of the first network device and the second network device, and received by a second receiving unit of the terminal device; and
determining, for the first and second receiving units, the at least one best reference signal resource received by each receiving unit.

2. The method of claim 1, wherein the terminal device is configured with a reporting setting configuration to control the terminal device to obtain receiving unit specific measurement results.

3. The method of claim 2, wherein the reporting setting configuration is provided by an information element with a first higher layer parameter set to a first value to control the terminal device to obtain receiving unit specific measurement results.

4. The method of claim 2, wherein the reporting setting configuration provides a second higher layer parameter that provides an index for one of at least one receiving unit of the terminal device.

5. The method of claim 1, wherein the reference signal resources comprise at least one of the following: channel state information reference signal (CSI-RS) resources or synchronization signal block (SSB) resources or synchronization signal/physical broadcast channel (SS/PBCH) blocks.

6. The method of claim 2, wherein the measurement results comprise at least one of the following: layer 1 reference signal received power (L1-RSRP) measurement results or layer 1 signal to interference noise ratio (L1-SINR) measurement results.

7. The method of claim 2, wherein the reporting setting configuration provides a third higher layer parameter that provides the number of receiving units that are to be used to perform reference signal resource measurement.

8. The method of claim 2, further comprising generating, by the terminal device, a reference signal resource indicator report stating channel state information reference signal resource indicators (CRIs) or synchronization signal block resource indicators (SSBRIs),
wherein the reporting setting configuration provides a fourth higher layer parameter that provides the number of CRIs or SSBRIs in each reference signal resource indicator report.

9. The method of claim 2, wherein the reporting setting configuration provides a fifth higher layer parameter that provides the number of reference signal resources that are to be reported for each receiving unit.

10. The method of claim 2, further comprising transmitting, by the terminal device, one CRI or SSBRI, a plurality of measurement results, and one index that identifies the receiving unit that is used to measure the plurality of measurement results.

11. The method of claim 2, wherein the terminal device is configured with a first resource setting with a first number (N1) of reference signal resources and is configured with a second resource setting with a second number (N2) of reference signal resources.

12. The method of claim 11, further comprising generating, by the terminal device, a reference signal resource indicator report stating two sets of CRIs or SSBRIs and corresponding measurement results.

13. The method of claim 12, wherein the CRIs or SSBRIs in the first set are selected from the reference signal resources in the first resource setting and the CRIs or SSBRIs in the second set are selected from the reference signal resources in the second resource setting.

14. The method of claim 12, wherein the first set of CRIs or SSBRIs comprises 2×K reference signal resource indicators and the second set of CRIs or SSBRIs comprises 2×K reference signal resource indicators, and wherein K CRIs or SSBRIs in the first set are selected from the reference signal resources in the first resource setting and the other K CRIs or SSBRIs in the first set are selected from the reference signal resources in the second resource setting.

15. The method of claim 2, wherein the best reference signal resource for each receiving unit is determined as the reference signal resource received by the receiving unit which has the best measurement result.

16. The method of claim 15, wherein the best reference signal resource for each receiving unit is determined as the reference signal resource received by the receiving unit which has the highest received power.

17. The method of claim 2, wherein the terminal device determines the at least one best reference signal resource received by each of the first and second receiving units.

18. The method of claim 4, further comprising:
generating, by the terminal device, a reference signal resource indicator report stating measurements of each reference signal resource labelled with the index, and
transmitting the reference signal resource indicator report for at least one of the first and second network devices.

19. A terminal device, comprising:
a transceiver, comprising a first receiving unit and a second receiving unit,
a processor, and
a memory, storing program instructions executable by the processor, wherein
the program instructions are configured to, when executed by the processor, control the transceiver and cause the processor to perform operations including:
measuring at least one reference signal resource transmitted by at least one of a first network device and a second network device, and received by the first receiving unit of the terminal device;
measuring at least one reference signal resource transmitted by at least one of the first network device and the second network device, and received by the second receiving unit of the terminal device; and
determining, for the first and second receiving units, the at least one best reference signal resource received by each receiving unit.

20. A network device, comprising:
a transceiver,
a processor, and
a memory, storing program instructions executable by the processor, wherein
the program instructions are configured to, when executed by the processor, control the transceiver and cause the processor to perform an operation including:
transmitting at least one reference signal resource to a terminal device, wherein
the at least one reference signal resource is configured to be received by a first receiving unit and a second receiving unit of the terminal device, such that the at least one best reference signal resource received by each receiving unit is determined for the first and second receiving units.
